(19) United States
(12) Patent Application Publication
(10) Pub. No.: US 2008/0288313 A1
(43) Pub. Date: Nov. 20, 2008

(54) SYSTEMS AND METHODS FOR EVALUATING ENTERPRISE ISSUES, STRUCTURING SOLUTIONS, AND MONITORING PROGRESS

(75) Inventors: Gregory K. Morris, Chicago, IL (US); Peter D. Gunter, Alexandria, VA (US); Oliver G. Prince, JR., Chicago, IL (US)

Correspondence Address: BELL, BOYD & LLOYD, LLP, P.O. Box 1135, CHICAGO, IL, 60690, US

(73) Assignee: MORRIS & GUNTER ASSOCIATES LLC, Chicago, IL (US)

(21) Appl. No.: 12/122,324

(22) Filed: May 16, 2008

Related U.S. Application Data
(60) Provisional application No. 60/938,778, filed on May 18, 2007.

(51) Int. Cl. G06Q 10/00

(52) U.S. Cl. 705/7

(57) ABSTRACT

The present disclosure provides systems and methods for evaluating business issues, structuring solutions, and monitoring progress that enable organizations to capitalize on organizational intelligence and intrinsic knowledge. In an embodiment, the method comprising: defining a framework that includes an executive level task related to work for operating an organization, directing level task related to the executive level task, and a managing level task related to the directing level task; defining a point-of-view of interest; generating a criteria related to the managing level task and the point-of view; generating a question related to the criteria; gathering input relating to the question; determining a score based on the input; and generating a profile based on the score. The score may be based on an achievement value, criteria weights and question weights. The inputs may come from individual interviews, facilitated group sessions, electronic surveys, internal reviews, and/or document reviews.

### CROSS REFERENCES TO RELATED APPLICATIONS

The present application claims priority to U.S. provisional application 60/938,778 filed in the United States Patent and Trademark Office on May 18, 2007, the entire contents of which are incorporated herein by reference.

### COPYRIGHT NOTICE

A portion of the disclosure of this patent document contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Conventional management systems and methods used by organizations to evaluate business issues, structure solutions, and monitor progress are deficient in that they lack the technical ability to accurately capture and employ knowledge in a systematic manner. Such conventional management systems are organized around organizational structure, specific processes or metrics, or other variable features of an organization. These conventional systems or methods fail to comprehensively describe, evaluate and otherwise account for the tangible and intangible tasks required to operate any enterprise, or capture and measure the tangible and intangible value drivers of the enterprise, such as leadership, communication, knowledge, critical thinking, execution, and innovation.

Example models for evaluating enterprise-wide risk fail to comprehensively and systematically analyze internal and external risks associated with each task necessary to operate an enterprise. Such models focus on specific areas of organizational risk, primarily fiscal controls and IT capabilities. These models may include a category for operational risk, but do not define that category systematically as they do other categories of risk. They do not systematically address risks associated with intangible facets of the business operation, the source of much of the enterprise value. The models do not expand the analysis to encompass the entire organization by evaluating the tasks performed within the organization using, among other things, cost and frequency parameters. As such, the models fail to fully identify the potential for risks that effect the related tasks, thus negatively impacting the organization's strategic competitive advantage.

Accordingly, there is a continuing need to provide new and novel systems and methods for evaluating an enterprise that enable businesses to capitalize on organizational intelligence and intrinsic knowledge to capture knowledge, measure performance and risk, and create value.

### SUMMARY

The present disclosure provides systems and methods for evaluating business issues, structuring solutions, and monitoring progress that enable organizations to capitalize on organizational intelligence and intrinsic knowledge through the use of a framework and a set of evaluation processes. In an exemplary embodiment, the method comprises: defining a framework that includes an executive level task related to work for operating the organization, a directing level task related to the executive level task, and a managing level task related to the directing level task; defining a point-of-view of interest; generating a criteria related to the managing level tasks and the point-of view of interest; generating a question related to the criteria; gathering input relating to the question; determining a score based on the input; and generating a profile based on the score. In another embodiment, the framework includes a sub-level task related the managing level task. In another embodiment, the method includes defining a solution based on one or more profiles. In another embodiment, the method includes generating a comparison profile of multiple profiles.

In another embodiment, the system comprises a memory device and a processor in communication with the memory device. The memory device stores a database that includes information concerning an executive level task related to work for operating an organization, a directing level task related to the executive level task, and a managing level task related to the directing level task. The database further contains information regarding a point-of-view of interest, a criteria related to the managing level task and the point-of view of interest, and a question related to the criteria. In an embodiment, the system includes an input mechanism for capturing input relating to the question. The processor is operable to calculate a score based on the input and generate a profile based on the score.

In another embodiment of the method disclosed herein, the method comprises the steps of: defining a framework that includes an executive level task related to the organization, a directing level task related to the executive level task, and a managing level task related to the directing level task; defining a point-of-view of interest wherein the point of view of interest is related to at least one of the executive level task, directing level task, and managing level task; generating a criteria related to the point-of view of interest; generating a question related to the criteria; gathering input relating to the question; determining a score based on the input; and generating a profile based on the score.

In one embodiment of the systems and methods disclosed herein, the score may be based on an achievement value, criteria weights and/or question weights. In another embodiment, the input may come from individual interviews, facilitated group sessions, electronic surveys, internal reviews, and/or document reviews.

Additional features and advantages of the present disclosure are described in, and will be apparent from, the following Detailed Description and the Figures.

### BRIEF DESCRIPTION OF THE FIGURES

FIG. 1 is a table of an embodiment of the disclosed systems and methods.

FIG. 2 is a flow chart of embodiment of the disclosed systems and methods.

FIG. 3 is a screen shot of an embodiment of the disclosed systems and methods.

FIG. 4 is a screen shot of an embodiment of the disclosed systems and methods.

FIGS. 5a and 5b are screen shots of an embodiment of the disclosed systems and methods.

FIG. 6 is a table of an embodiment of the disclosed systems and methods.

FIG. 7 is a table of an embodiment of the disclosed systems and methods.

### DETAILED DESCRIPTION

The embodiments disclosed herein are systems and methods for evaluating business issues, structuring solutions, and monitoring progress that enable organizations to capitalize on organizational intelligence and intrinsic knowledge through the use of a framework and a set of evaluation processes. The systems and methods disclosed herein have application from many points-of-view, including, but not limited to, strategic alignment, information technology (“IT”) and other functional alignment, business performance management, change leadership, due diligence, integration, enterprise risk management, transformation, and resilience. A point-of-view is an area of interest for analysis of a business entity. Each point-of-view of interest relates to criteria that has its own associated set of questions that enable the organization to capture and analyze knowledge, measure performance and risk, and create value.

The framework reflects work for operating an enterprise or organization. In one embodiment, the work for operating an enterprise or organization reflects a set of tangible and intangible tasks. In another embodiment, the work for operating an enterprise or organization reflects a set of tangible and intangible tasks required of the managers/leaders at any level of an enterprise or organization. The disclosed systems and methods offer a substantive, comprehensive, and repeatable technical framework for managing an enterprise that can be taught, learned, and tested. In an embodiment, the framework also captures and measures both the tangible and the intangible value drivers of the enterprise. For example, intangible value drivers may include, but are not limited to, leadership, communication, knowledge, critical thinking, execution and innovation.

Any organizational unit can be described and evaluated around a comprehensive representation of tasks necessary to operate an enterprise. The framework enables users across all industry verticals to organize thought systematically and to rapidly evaluate and communicate numerous facets of organizational function. The tasks necessary to operate an organization are aggregated into discrete units.

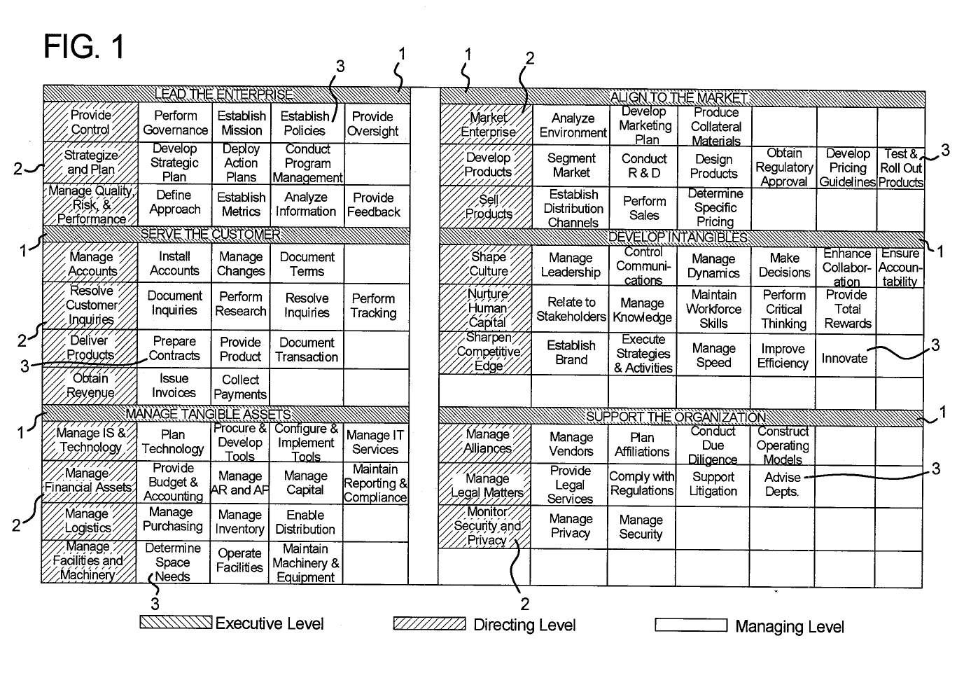

Referring to FIG. 1, the table discloses an exemplary embodiment of the framework. Work activities are grouped, for example, into six executive level tasks as represented by cells 1. These executive level tasks are tasks at the highest level that collectively define the work needed to run any enterprise or organization. As shown in FIG. 1, executive level tasks can include: Lead the Enterprise; Align with the Market; Serve the Customer; Develop Intangibles; Manage Tangible Assets; and Support the Organization.

Each enterprise level task may have one or more directing level tasks 2 associated with it. Directing level tasks are tasks at the next highest level beneath or related to the executive level tasks that collectively define the work needed to run any enterprise or organization. The directing level tasks associated with an executive level task collectively define the work associated with that task. For example, as depicted in FIG. 1, the directing level tasks related to the enterprise task 1 “Lead the Enterprise” can include: Provide Control; Strategize and Plan; and Manage Quality, Risk & Performance. In the embodiment depicted, there are twenty directing level tasks associated with the six executive level tasks. In other embodiments, any number of directing level tasks can be associated with the executive level tasks.

Each directing level task may have one or more managing level tasks 3 associated with it. Managing level tasks are tasks at the next highest level beneath or related to the directing level tasks that define the work needed to run any enterprise or organization. The managing level tasks associated with a directing level task collectively define the work associated with that task. For example, as depicted in FIG. 1, the managing level tasks 3 related to the directing task 2 “Provide Control” under the enterprise task 1 “Lead the Enterprise” can include: Perform Governance; Establish Mission; Establish Policies; and Provide Oversight. In the embodiment depicted, there are seventy-five managing level tasks associated with the twenty directing level tasks and six executive level tasks. One of skill in the art would appreciate that any number of executive, directing, or managing level tasks may be employed with the systems and methods disclosed herein. In another embodiment, there are further sub-levels of tasks below the managing level tasks.

The systems and methods call for capturing business intelligence and organizing that knowledge along the framework and a particular point-of-view. A point-of-view index is a subset of criteria and question sets, described below, related to the point-of-view of immediate interest, or the particular application of the systems and methods disclosed herein. In one embodiment, points-of-view include strategic alignment, performance, integration, risk, and change leadership. Other examples of the potentially unlimited number of points-of-view include roles, processes, and inventories of skills, IT and functional alignment, business performance management, due diligence, transformation, and resilience. In an embodiment, intelligence accumulated about a point-of-view is available and accessible when evaluating all other points-of-view (because all knowledge elements, i.e., answers to questions in the question sets, are indexed to the framework).

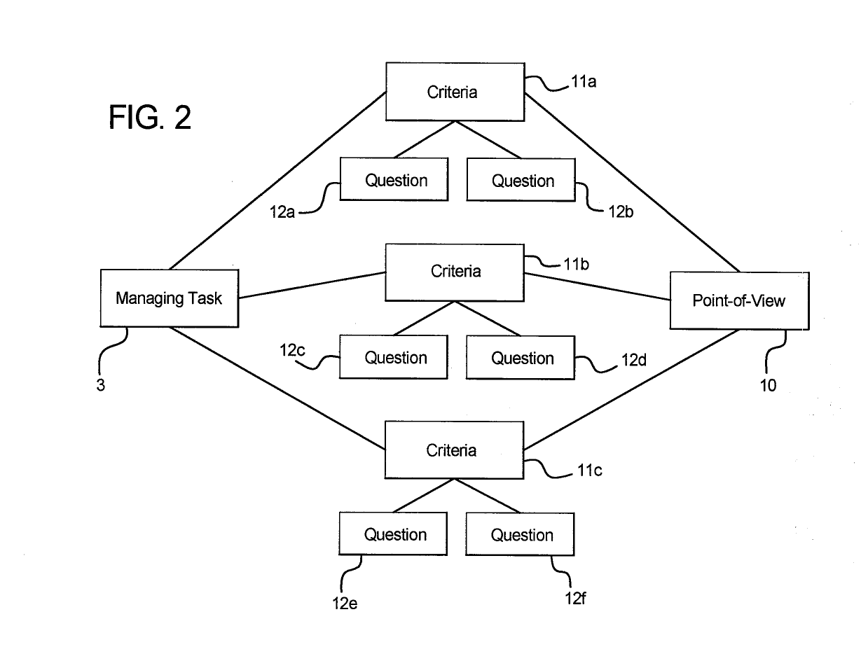

Referring to FIG. 2, the managing tasks 3 and the point-of-view of interest 10 are associated through criteria 11a to 11c and a set of questions 12a to 12f, collectively referred to as an “analytic index.” In another embodiment, the point-of-view of interest 10 is associated to directing or executive level tasks. The analytic index represents knowledge for evaluating aspects of enterprise functionality. In one embodiment, the analytic index includes numerous criteria 11a-11c and questions 12a-12f associated with a managing task 3 that are designed to elicit information to evaluate the organization from the point-of-view of interest (e.g., potential company integration, performance analysis, due diligence). A criteria represents knowledge necessary to evaluate a particular task. For example, in one embodiment, the criteria related to the “Perform Governance” managing task when evaluating the “performance” point-of-view are:
1. Board of directors has the appropriate composition (skill set, diversity, experience);
2. Organization can clearly state its beliefs and values;
3. Organization has complete and clear by-laws; and
4. Relationship between board and organization's management is clearly established and cooperative.
   In another embodiment, the criteria are related to sub-level tasks which are related to the managing level tasks.

Each criteria has a set of one or more questions associated with it in order to obtain the knowledge necessary to evaluate a particular task. Referring again to FIG. 2, criteria 11a has questions 12a and 12b associated with it. Criteria 11b has questions 12c and 12d, and criteria 11c has questions 12e and 12f. It should be appreciated that any number of questions can be associated with a particular criteria. As an example of the questions, in one embodiment, the questions related to the “Board of directors has the appropriate composition (skill set, diversity, experience)” criteria are:
1. Do members of the board of directors have the skill sets appropriate for the type of business in which the organization is involved?;
2. Do members reflect the diversity of the community or backgrounds that would assist the organization in understanding various points of view?
3. Is the level of experience of the board members adequate?
4. Has the membership of the board of directors shown the appropriate level of stability?
5. Does the organization have a clear understanding of the desired composition of the board of directors?
   The above are exemplary questions that may be appropriate for the particular criteria and point-of-view. One of skill in the art would appreciate that any number and type of criteria and questions may be utilized with the disclosed systems and methods. In another embodiment, the analytic index contains only question sets without the associated criteria.

The questions may be of one or more differing question types. In one embodiment, there are four question types: 1) Objective—non quantitative questions that can be answered with a definitive response (e.g. yes/no); 2) Qualitative—Questions that can be answered based on the individual's assessment and that may be subject to interpretation; 3) Quantitative financial—financial questions that can be answered with a numeric response typically taken from the organization's financial statements or management reports; and 4) Quantitative operational—questions that evaluate various operational activities or outcomes of an organization.

The criteria and question sets may be unique to a particular point-of-view of interest. Alternatively, the criteria and the question sets are relevant to multiple points-of-view. For example, in one embodiment, the criteria 11a (e.g., “Organization has complete and clear by-laws”) is relevant to multiple points-of-view, including strategic alignment, performance, risk, and change leadership. In an alternate embodiment, criteria 11a is relevant only to one point-of-view of interest. In another embodiment, only some of the questions for a criteria are relevant for a particular point-of-view. For example, in an embodiment, criteria 11a is relevant to multiple points-of-view, but question 12b is only relevant to one of those points-of-view.

In one embodiment, the systems and methods disclosed herein include at least one processor, such as a microprocessor. The processor is in communication with or operable to access or to exchange signals with at least one data storage or memory device. In an embodiment, the processor and the memory device reside together within a computer. Alternatively, the memory device may be attached to the processor via a network. In one embodiment, the memory device includes internal or external hard disk storage devices. Alternatively, the memory device may be a detachable or removable memory device, including, but not limited to, a suitable cartridge, disk, CD/ROM, DVD or USB memory device. Alternatively, the memory device includes random access memory (RAM). The memory device may include read only memory (ROM). Any other suitable memory device may operate in conjunction with the systems disclosed herein.

The memory device stores program code and instructions, executable by the processor, to perform the operations described herein, such as perform calculations, access data, and generate reports or profiles. The memory device also stores a database. In one embodiment, the database and program code are contained in separate memory devices. In other embodiments, part or all of the program code and/or data stored in the database described above can be downloaded to the memory device through a suitable network.

In one embodiment, the present systems and methods can be implemented using a desktop computer, a laptop personal computer, a personal digital assistant (PDA), portable computing device, mobile phone, server, or other computerized platform to implement the present disclosure. In one embodiment, the systems and methods disclosed herein are operable over a network, such as the Internet or a wireless network.

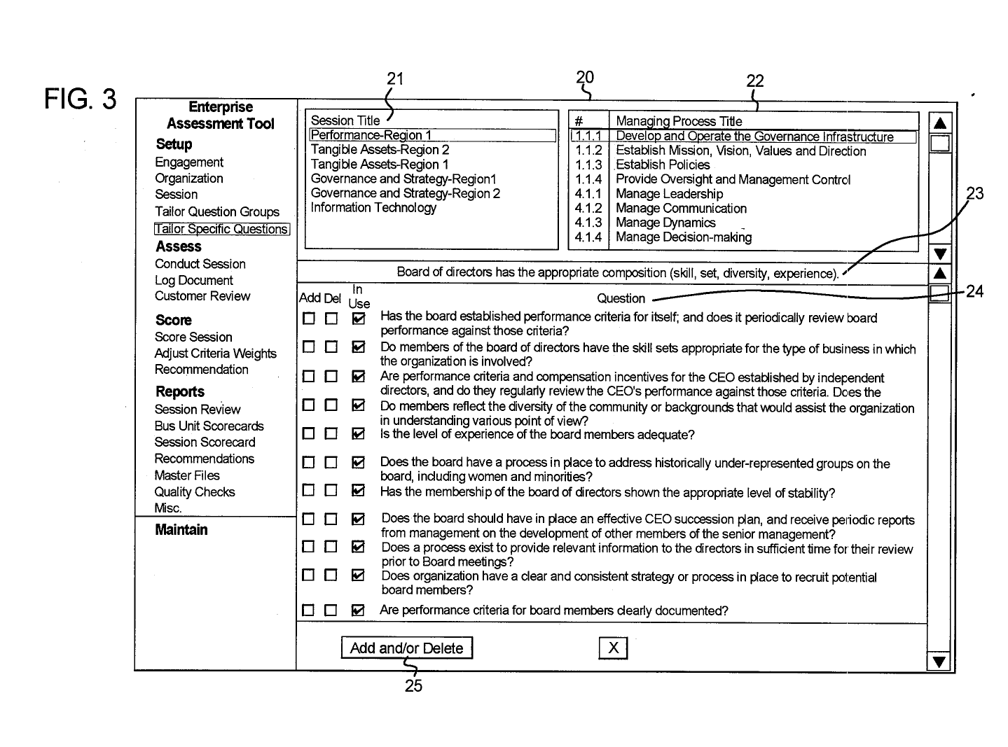

In one embodiment, the tasks, criteria, question sets, and inputs, or answers to the questions, are stored in a database that is connected to a user interface that allows input and output of the data. For example, the systems and methods may be implemented using a Microsoft Access database application. Alternatively, the database application may be in another database format, such as Oracle or Microsoft SQL Server, or any other suitable database format. In such an embodiment, the database is interacted with by a web or software application user interface as is depicted in FIGS. 3 to 5. The user interface can be implemented in program code using any known programming technology, including, but not limited to, Microsoft Net, Microsoft Active Server Pages, Java, Javascript, C++, or PhP.

Referring to FIG. 3, one embodiment of a user interface 20 for setting up a question set for a particular evaluation is shown. The user interface is configured to allow the user to choose the relevant questions in the questions area 24 of the interface for the criteria 23 “Board of directors has the appropriate composition (skill set, diversity, experience)” for the selected “Governance” managing task in selection box 22 for the selected “Performance” point-of-view in selection box 21. To add or delete questions from the evaluation for the selected “Performance” point-of-view for the selected “Governance” managing task, the user selects the appropriate check box in question area 24 and presses the “Add and/or Delete” button 25.

In one embodiment, inputs, or answers to the questions, come from individual interviews with an employee of the organization being evaluated. The individual interviews may be conducted with various employees or persons associated with an organization that can provide answers to the specific questions relating to the managing task. The interviews may be conducted in-person, via telephone, e-mail, or other communication means. The individual interviews are conducted by an consultant outside of the enterprise, or alternatively, by in-house personnel. In other embodiments, inputs are gathered from facilitated group sessions, electronic surveys, internal reviews or investigations, or document reviews.

For example, an electronic survey or online survey is hosted by a web server to gather inputs to the question sets. The organization sends out an e-mail communication to its employees to request that they fill out the online survey. The e-mail may contain a hyperlink to the online survey. In one embodiment, each employee fills out a set of questions pertaining to the relevant criteria and managing tasks for the point-of-view of interest. In another embodiment, employees fill out surveys consisting of only questions relevant to their job descriptions. The online surveys may be built and maintained by a third-party service provider or in-house by the organization. In another embodiment, the electronic survey may be conducted via software installed at each employees workstation.

Alternatively, inputs may be gathered by a review of documents. For example, a third-party consultant reviews relevant documents and answers the relevant questions, or the organization dedicates an in-house employee to review existing documents and new documents as they are generated to ensure a timely capturing of knowledge and awareness of problems regarding any point-of-view of interest and/or managing task. In another embodiment, inputs are extracted from information systems used to support operation of the organization, or its subunits. Extracts can be printed or in electronic formats.

In one embodiment, the inputs are stored in a database. The inputs are loaded or captured in the database through an input mechanism in communication with the processor, such as a keyboard, mouse, light pen, touch screen, or a wirelessly connected device, such as a mobile phone or other handheld device.

In an embodiment, the user operates the input mechanism to interact with a user interface for a software or database application. In an embodiment, the software or database application is web-enabled. In other embodiments, the database application operates over a network, on a personal computer or laptop, or on a handheld device.

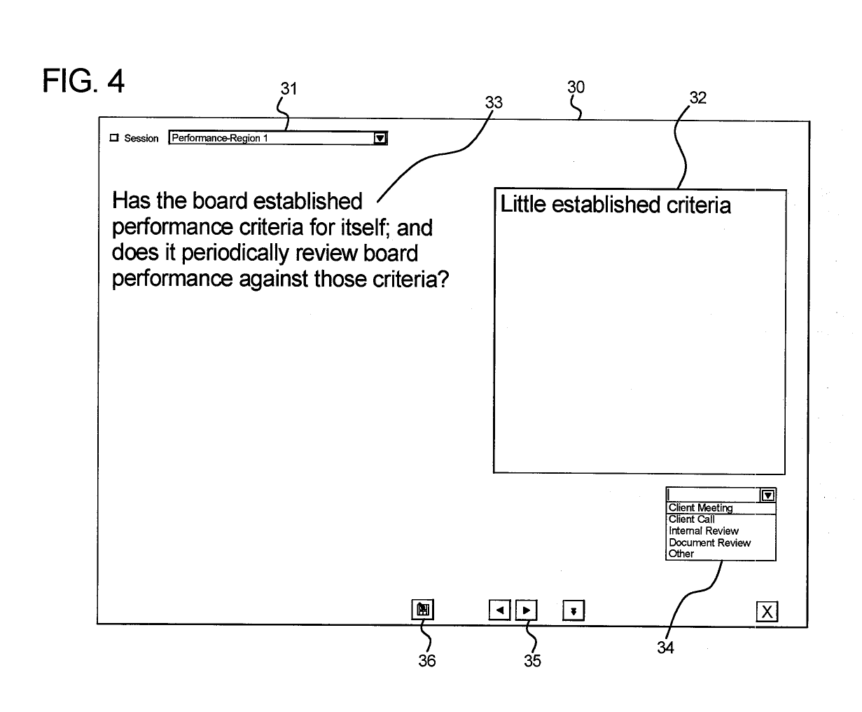

Referring to FIG. 4, one embodiment of a user interface 30 of the software or database application is shown. For the selected point-of-view session 31, the user of the database application is prompted with the selected series of questions as described above. In one embodiment, the user is the employee respondent who fills out an electronic survey to answer the questions. In another embodiment, the user is a third-party consultant performing the evaluation of the organization who manually collects the inputs from the employee respondents and then enters the inputs or answers into the database application at a later time. The user accessing the user interface 30 may be prompted with the particular question 33 and provided an answer box 32 to enter the answer. The user may select the source of the answer using a selection box 34. In an embodiment, the user then presses the next button 35 to answer the next question in the question set. Alternatively, the user may be prompted with multiple questions at one time. When the user is done answering all the questions, they press the save button 36.

The disclosed systems and methods score the results of the inputs, or answers to the question sets, to determine how well the inputs achieve the objectives of the criteria and questions for the point-of-view of interest. The scores may be adjusted by a weighting mechanism that allows independent weighting of each question and criterion on a scale from 0 to 10. In one embodiment, the scores may not be weighted, or may be weighted using a different scale.

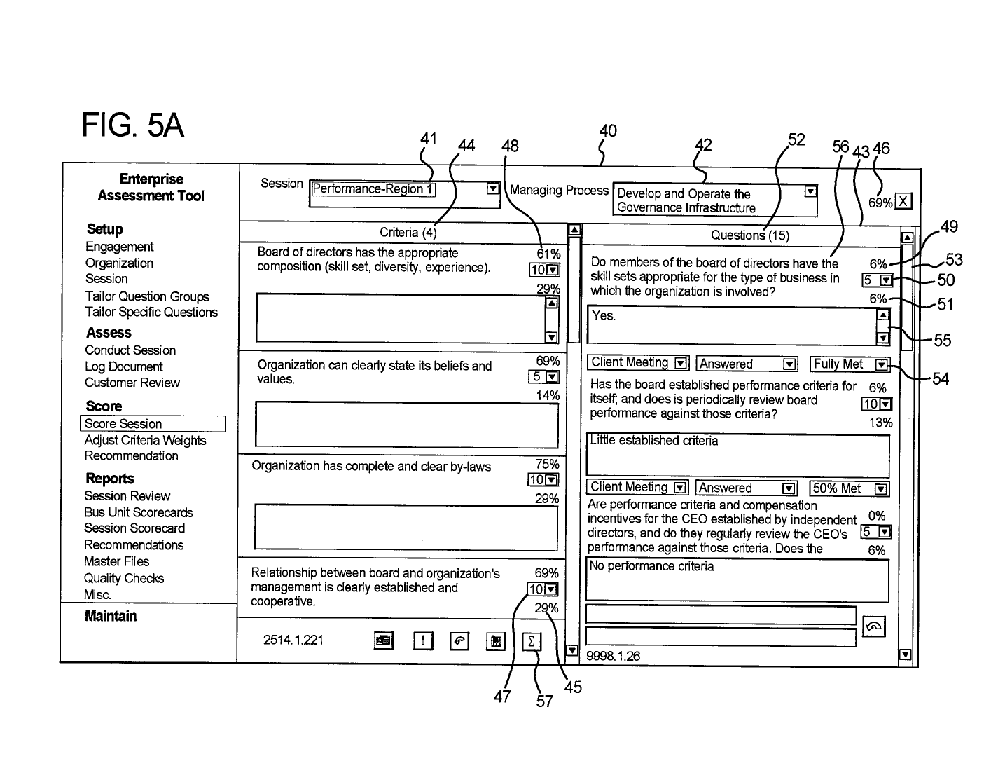

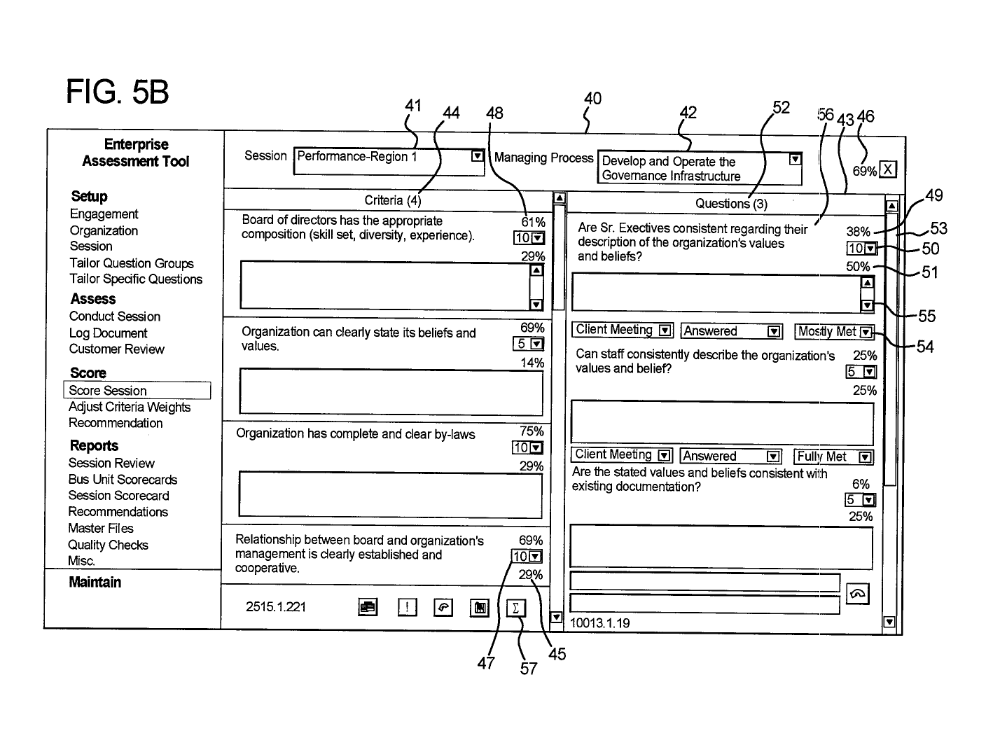

Referring to FIGS. 5a and 5b, an embodiment of a user interface 40 to a database application is shown where an evaluator of the organization or enterprise scores the results of the inputs to the questions to determine an overall score for a particular managing task, using a weighting mechanism at both the criteria and question level. The evaluator selects the point-of-view of interest from the selection box 41 and selects the managing task to score from selection box 42. The user interface then displays the analytic index scoring window 43 for the chosen managing task 42.

For the chosen managing task, there are four criteria illustrated in the criteria portion 44 of the analytic index scoring window 43 in FIG. 5a. A criteria weight is used to calculate each criteria's weight percentage 45 and thus the overall management task score 46. In one embodiment, for each criteria, the evaluator selects a criteria weight from the criteria weight selection box 47. A criteria weight is a value used for scoring that represents the relative importance of the particular criteria and its underlying question set to the managing task score 46.

Each criteria for a managing task may be assigned a weight from 0 to 10. For example, in the disclosed embodiment, three of the four criteria have criteria weights of 10 and one of the criteria has a criteria weight of 5 as shown in the criteria weighting selection boxes 47. In this example, a score of 10 means that 29% (rounded) of the managing task's overall score comes from the criteria as shown in the criteria weight percentage display area 45. Likewise, a score of 5 means that the criteria weight percentage is 14% (rounded). This calculation is done based on the following formula: criteria weight/total criteria weights (e.g., 10/35).

Criteria score 48 may be calculated by summing the question scores 49 for each question in the question set for the criteria. In FIG. 5a, the user interface displays fifteen questions in the question set portion 52 of the analytic index scoring window 43 that are related to the first criteria displayed in the window 43 (“Board of directors has the appropriate composition (skill set, diversity, experience)”). To view and score each question, the evaluator uses scrollbar 53 to scroll the window. In one embodiment, to score the questions for the other criteria, the evaluator uses a mouse or other computer input device to click on the other criteria in the criteria portion 44 of the analytic index scoring window 43. For example, in FIG. 5a, if the evaluator clicks on the second criteria title, “Organization can clearly state its beliefs and values,” the screen embodiment in FIG. 5b appears, displaying the question set for the selected second criteria. In another embodiment, the user interface is designed so that all of the questions for every criteria are displayed on the same screen.

To calculate the question score 49, the evaluator may assign a question weight to each question. Referring to FIGS. 5a and 5b, an evaluator assigns a weight from 0 to 10 by selecting a number from the question weight selection box 50. For example, in the disclosed embodiment, two of the three questions have questions weights of 5and one of the questions has a question weight of 10 as shown in the question weight selection boxes 50. In the example of FIG. 5b, a score of 10 means that 50% of the criteria score 48 comes from the question as shown in the question weight percentage display area 51. Likewise, a score of 5 means that the question weight percentage is 25%. This calculation is done based on the following formula: question weight/total question weights (e.g., 5/20).

Scoring may be accomplished through evaluator judgments whereby, based on the inputs to the questions (objective, quantitative or qualitative), an achievement value is assigned. The achievement value, or degree to which a question's objectives are achieved, may be determined based a likert scale. A likert scale is a type of psychometric response scale used in survey research. Generally, when responding to a likert questionnaire item, respondents specify their level of agreement to a statement (e.g., fully met, mostly met, 50% met, mostly unmet, unmet). In an embodiment, the determination of the achievement value is indirect based on the skill, knowledge, and experience of the evaluator. In another embodiment, the determination of the achievement value is direct based on the input to the question, such as when the question type is quantitative or objective.

In one embodiment of the disclosed systems and methods, an evaluator of the organization reviews the inputs to the questions and assigns a likert scale achievement value to each answer. Referring to FIG. 5b, the evaluator uses selection box 54 to choose an achievement value (e.g., fully met, mostly met, 50% met, mostly unmet, unmet) as to whether the input 55 meets the objective of question 56. A numeric achievement value representing the selected likert scale style achievement value may be used in the calculation of the question score 49, such as “fully met”=1, “mostly met”=0.75, “50% met”=0.5, “mostly unmet”=0.25, and “unmet”=0. The selected or entered achievement value may also be a numeric value, such as a percentage or a value between 0 and 10.

In an alternative embodiment, the achievement values are automatically assigned based on the inputs to the questions, without evaluator judgment. For example, in such an embodiment, for questions requiring a “yes” or a “no” answer, the achievement value is assigned either a 1 (“yes”) or a 0 (“no”). In another embodiment, quantitative questions may be used to obtain a numerical answer or input, where a formula is used to determine an appropriate achievement value, such as where the input falls within a predetermined range of possible answers. For example, such quantitative questions may relate to financial targets, work hours, or salary, or require answers to be on a scale of 1 to 10.

Once all of the achievement values 54 are assigned, either manually or automatically, and the question weights 50 and criteria weights 47 are chosen, the evaluator presses the score calculation button 57 to calculate the (1) question scores 49, (2) criteria scores 48, and (3) the management task score 46. In another embodiment, the overall distribution of weights and the calculation of the scores is automatically done with each modification to a value or weight. In one embodiment, question score 49 is calculated by multiplying achievement value 54 by question weight 50. In an embodiment, criteria score 48 is calculated by summing question scores 49 for the questions in the question set. In an embodiment, management task score 46 is the sum of each criteria score 48 multiplied by its corresponding criteria weight percentage 45.

For example, referring to FIG. 5b, the question score 49 shown as 38% is calculated by multiplying the achievement value 0.75 (“mostly met”) by its question weight percentage 50% (with rounding). The criteria score 48 shown as 69% for the second criteria (“Organization can clearly state its beliefs and values”) in the criteria portion of the window 43 is the sum of the question scores for the criteria (38% +25% +6%). Likewise, each criteria score 48 represents the sum of the question scores for the corresponding criteria. The management task score 46 shown as 69% is the sum of each criteria score 48 multiplied by its corresponding criteria weight percentage 45 divided by 100. For example: (61*0.29)+(69*0.14)+(75*0.29)+(69*0.29)=69%. In an embodiment, the above process is repeated for each managing task that is relevant to the point-of-view of interest. As discussed above, in other embodiments one or more managing task scores can be automatically calculated without user/evaluator interaction where an evaluator's subjective judgment is not required to assign an achievement value.

It should be appreciated that the above embodiments are only illustrative and not intended to restrict the process by which scores are generated for the managing tasks in the framework. For example, in one embodiment, no weighting is performed at the criteria and/or the question level to calculate a managing task score. In another embodiment, the scores are manually generated through the use of a value judgment without the use of a database.

The scores may be translated into a profile, or report card or scorecard presentation, that displays the scores achieved. In one embodiment, the numerical scores are displayed. In another embodiment, a letter grade (e.g., A-F) is displayed. In another embodiment, scores are reflected on the report by shading the task a color, such as red (significant challenges), yellow (performs adequately), or green (performs well). For example, if the managing task score is less than 60%, the score is depicted as red, 60 to 79% is yellow, and greater than 80% is green. In another embodiment, the profile is a radar or spider diagram. In another embodiment, the profile is a graph, such as a bar graph. In another embodiment, the profile is based directly on inputs to the questions. One of skill in the art would appreciate that the profile, or report card, may represent the scores or inputs to the questions in any other suitable manner.

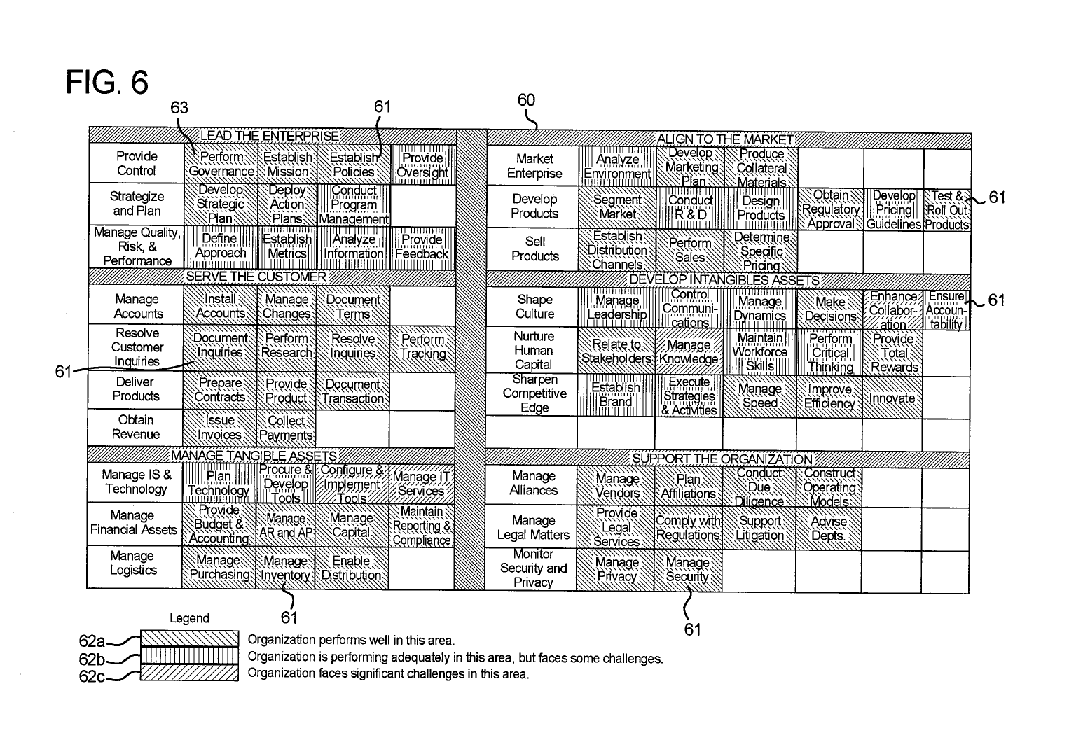

Referring to FIG. 6, an exemplary table format profile 60 is generated that includes all of the executive, directing, and managing level tasks. Each managing level task 61 is shaded according to the shading colors 62a-c to represent the score for the task. For example, tasks shaded according to shading 62a (e.g., green) are those where the “Organization performs well in this area.” As described above, in one embodiment, this is where the managing task score is greater than 75%. Likewise, tasks shaded according to 62b (e.g., yellow) are those whose score is 50 to 75% (“Organization is performing adequately in this area, but faces some challenges”), and tasks shaded according to 62c (e.g., red) are those whose score is less than 50% (“Organization faces significant challenges in this area”). As shown in box 63, the organization performs well in the “Perform Governance” managing task as it is shaded according to 62a. However, the organization faces some challenges in the “Provide Oversight” managing task area, three boxes to the right, as it is shaded according to 62b.

The generation of a detailed profile or scorecard representing scores based on inputs to question sets and criteria related to managing tasks and the particular point-of-view of interest allows an organization to evaluate organizational knowledge, measure performance strengths and weaknesses, and create value. The repeatable systems and methods allow for enhanced management in many ways. Its most basic application is as a discussion guide. Teams use the systems and methods as a reference tool to create an understanding of strengths, weaknesses, opportunities, and threats, and of actions to be taken.

The systems and methods disclosed herein may be repeatable for multiple studies or evaluations. The evaluation profiles for each evaluation may be overlaid or compared against each other. For example, a first evaluation is performed, generating a profile that identifies several areas where the enterprise needs to improve. The enterprise then takes corrective actions based on the results of the first evaluation. A second evaluation is performed at a later date to identify if there were improvements in the areas previously identified that needed improvement, or if the corrective actions had any impact on other areas of the enterprise. In another embodiment, the systems and methods can be used for predictive modeling of enterprise organizational configurations. In another embodiment, the systems and methods can be used for predicative modeling of enterprise process configurations. In another embodiment, the systems and methods can be used for predictive capabilities to identify process or organizational impacts from the elimination of any selected subset of businesses, departments, or employees. In another embodiment, results are evaluated by comparison of a current result to other current results, historical or benchmark results, or calculations. The repeatable nature of the disclosed systems and methods thus enable an enterprise to easily identify issues, structure solutions, and monitor progress.

In one embodiment, supporting tools created using spreadsheet, word processing, or database applications are used to assist in the evaluation of a profile. These include tools for comparative analysis of organizations or their components, integration planning, audits of critical project, and decision monitoring and enhancement. In another embodiment, the supporting tools are a web-based system.

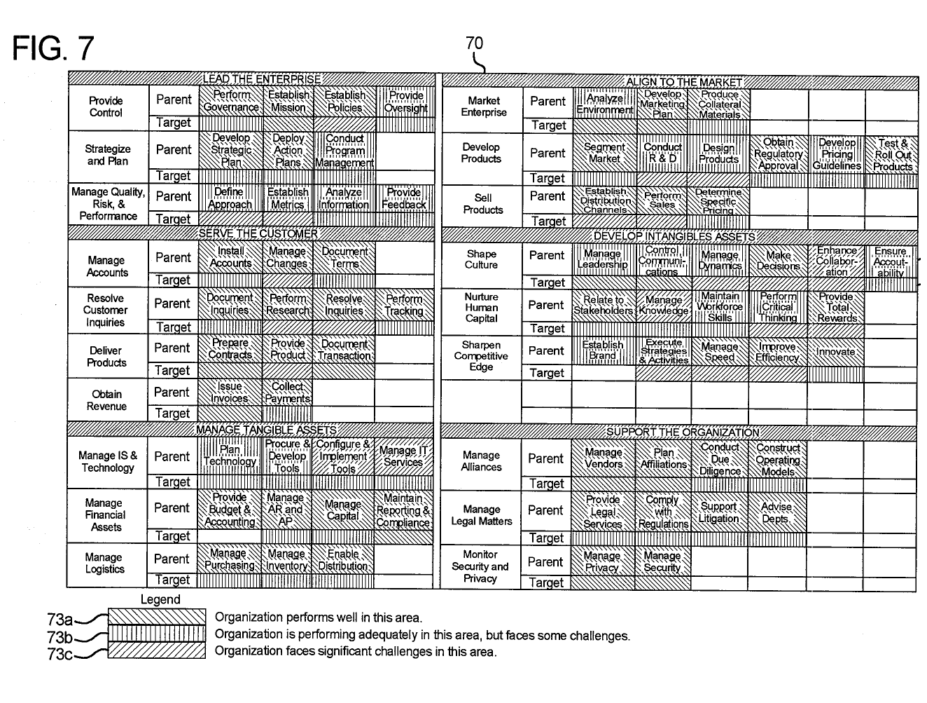

Another example of a point-of-view or application of the disclosed systems and methods is to analyze two or more organizations for merger or acquisition purposes. Using the systems and methods, an organization would be able to get a detailed understanding of the strengths and weaknesses of both its own organization and a target organization. Referring to FIG. 7, in one embodiment, a comparison profile 70 is generated that combines profiles of scores for managing tasks for a parent and target organization. As depicted in the managing task boxes on parent line 71 and target line 72 for the managing tasks associated with the “Shape Culture” directing tasks, the target organization performs well in the “Manage Leadership” and “Control Communications” areas as indicated by shading color 73a where the parent organization faces some challenges as indicated by shading color 73b. Thus, the profile provides valuable information about the capabilities of both organizations and guidance as to the best integration plan. The disclosed systems and methods allow the organization to get everyone on the same page, deploy newly enhanced capabilities to tackle operational challenges in a strategic way, and focus on boosting program management capabilities.

In another embodiment, scores can be assigned to managing tasks directly without answering a set of questions to obtain a high level qualitative assessments of an organization. In one embodiment, a electronic or online survey is created that allows users to complete a qualitative assessment of their organization by clicking on each of the managing tasks. Each task then displays a definition and can be scored as red, yellow, or green upon clicking the appropriate cell. In one embodiment, scores are submitted to an evaluator through e-mail or via the web.

Using the discloses systems and methods, in one embodiment, a solution to solving a problem or issue with an organization can be created based on the organization's profile for a point-of-view. Similarly, a solution can be crafted based on multiple profiles for different organizations for a particular point-of-view, such as a merger acquisition. Alternatively, a solution can be based on multiple profiles for an organization for different points-of-view.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for evaluating an organization, the method comprising:
defining a framework that includes an executive level task related to work for operating the organization, a directing level task related to the executive level task, and a managing level task related to the directing level task;
defining a point-of-view of interest;
generating a criteria related to the managing level task and the point-of-view of interest;
generating a question related to the criteria;
gathering input relating to the question;
determining a score based on the input;
generating a profile based on the score.

2. The method of claim 1 wherein the score is based on an achievement value.

3. The method of claim 1 wherein the score is based on criteria weights.

4. The method of claim 1 wherein the score is based on question weights.

5. The method of claim 1 wherein the input includes at least one of individual interviews, facilitated group sessions, paper surveys, electronic surveys, internal reviews, and document reviews.

6. The method of claim 1 wherein the framework includes a sub-level task related to the managing level task.

7. The method of claim 6 wherein the criteria is related to the sub-level task and the point-of-view of interest.

8. The method of claim 1 including generating a comparison profile of a plurality of profiles.

9. The method of claim 1 including defining a solution based on the profile.

10. The method of claim 1 including defining a solution based on a plurality of profiles.

11. A system for evaluating an organization, the system comprising:
a memory device;
a processor in communication with the memory device;
a database stored in the memory device, the database including information concerning:
an executive level task related to work for operating the organization,
a directing level task related to the executive level task,
a managing level task related to the directing level task,
a point-of-view of interest,
a criteria related to the managing level task and the point-of-view of interest, and
a question related to the criteria; and
an input mechanism in communication with the processor for capturing input relating to the question;
wherein the processor is operable to:
calculate a score based on the input; and
generate a profile based on the score.

12. The system of claim 11 wherein the score is based on an achievement value.

13. The system of claim 11 wherein the score is based on criteria weights.

14. The system of claim 11 wherein the score is based on question weights.

15. The system of claim 11 wherein the input includes at least one of individual interviews, facilitated group sessions, paper surveys, electronic surveys, internal reviews, and document reviews.

16. The system of claim 11 wherein the database includes information concerning a sub-level task related to the managing level task.

17. The system of claim 16 wherein the criteria is related to the sub-level task and the point-of-view of interest.

18. The system of claim 11 wherein the processor is operable to generate a comparison profile of multiple profiles.

19. The system of claim 11 wherein the processor is operable to generate a solution based on the profile.

20. A method for evaluating an organization, the method comprising:
defining a framework that includes an executive level task related to work for operating an organization, a directing level task related to the executive level task, and a managing level task related to the directing level task;
defining a point-of-view of interest wherein the point of view of interest is related to at least one of the executive level task, directing level task, and managing level task;
generating a criteria related to the point-of-view of interest;
generating a question related to the criteria;
gathering input relating to the question;
determining a score based on the input; and
generating a profile based on the score.
